(19) United States
(12) Patent Application Publication
(10) Pub. No.: US 2022/0230168 A1
(43) Pub. Date: Jul. 21, 2022

(54) SYSTEMS AND METHODS FOR TRANSACTION PRIVACY SHIELD

(71) Applicant: Wells Fargo Bank, N.A., San Francisco, CA (US)

(72) Inventors: Wayne Barakat, Novato, CA (US); Sotirios K. Barkas, San Jose, CA (US); David Newman, Walnut Creek, CA (US)

(21) Appl. No.: 14/981,045

(22) Filed: Dec. 28, 2015

(51) Int. Cl. G06Q 20/40; G06F 17/30; H04L 29/06

(52) U.S. Cl. CPC G06Q 20/40; H04L 63/10; G06F 17/30864

(57) ABSTRACT

A financial institution computing system includes a network circuit exchanging information over a network, a customer database storing financial information for a plurality of users, and a privacy shield circuit. The privacy shield circuit receives, over the network via the network circuit, a privacy shield request from an authorized user of a financial account via a user computing device. The privacy shield circuit generates a user alias for the authorized user of the financial account. The privacy shield circuit associates the user alias with the financial account in the customer database for use in conjunction with a subsequent transaction. Use of the user alias in conjunction with the subsequent transaction includes using the user alias for at least one of an authentication procedure and providing requested information to a merchant. The privacy shield circuit transmits the user alias to the user computing device over the network via the network circuit.

### BACKGROUND

Individuals are sometimes asked to provide information in connection with receiving various goods or services. Oftentimes, individuals are asked to verify their identities with a second party involved in the transaction, be it another individual, a group of individuals, a commercial entity, or a government entity. Merchants or service providers may require an individual to provide information such as the individual's name, address, credit card number, card security code, card expiration date, and so on. Merchants routinely capture and maintain such information about their customers and often indicate that the information is required for the transaction to be completed regardless of whether the information is actually required. For example, in addition to being asked to provide information needed by a credit company to approve a transaction, the customer may also be asked to provide additional information, such as telephone numbers and email addresses. Having to provide such information is frustrating for some individuals and viewed as an invasion of their privacy. For example, such information may be used by merchants to create mailing lists or to put the customer on existing mailing lists, oftentimes without the customer's knowledge or against the customer's will. For example, a customer who uses a credit card to pay to attend a seminar on managing specific health conditions may not wish to be placed on mailing lists associated with such medical conditions. Furthermore, providing such information (e.g., to an unscrupulous merchant or unsecure merchant database) may cause identity-theft issues for the individual.

### SUMMARY

One exemplary embodiment relates to a financial institution computing system. The financial institution computing system includes a network circuit, a customer database, and a privacy shield circuit. The network circuit enables the financial institution computing system to exchange information over a network. The customer database stores financial information for a plurality of users. The privacy shield circuit is configured to receive, over the network via the network circuit, a privacy shield request from an authorized user of a financial account via a user computing device. The privacy shield circuit is further configured to generate a user alias for the authorized user of the financial account and associate the user alias with the financial account in the customer database for use in conjunction with a subsequent transaction. Use of the user alias in conjunction with the subsequent transaction includes using the user alias for at least one of an authentication procedure and providing requested information to a merchant. The privacy shield circuit is further configured to transmit the user alias to the user computing device over the network via the network circuit.

Another exemplary embodiment relates to a method of authorizing a transaction request performed by a financial institution computing system. The method includes receiving, by a privacy shield circuit over a network via a network circuit, a transaction request from a transaction terminal, the transaction request including at least part of a user alias provided by a user or a user computing device. The method further includes comparing, by the privacy shield circuit, the at least part of the user alias to financial information stored in a customer database storing financial information for a plurality of users and determining whether the at least part of the user alias is associated with an authorized user of a financial account. The method further includes authorizing, by the privacy shield circuit, the transaction request based on at least information in the customer database and the user alias being associated with an authorized user of the financial account, and transmitting, by the privacy shield circuit, a confirmation to the transaction terminal over the network via the network circuit.

A further exemplary embodiment relates to a non-transitory computer readable media having computer-executable instructions embodied therein that, when executed by a transaction circuit of a financial institution computing system, causes the financial institution computing system to perform operations to authorize a transaction request. The operations include receiving a transaction request from a transaction terminal, the transaction request including at least part of a one-time-use user alias provided by a user or a user computing device. The operations further include comparing the at least part of the one-time-use user alias to information stored in a customer database storing financial information for a plurality of users and determining whether the at least part of the one-time-use user alias is associated with an authorized user of a financial account. The operations further include authorizing the transaction request based on whether the at least part of the one-time-use user alias is associated with an authorized user and information in the customer database and causing the one-time-user user alias to expire so that the one-time-use user alias cannot be used for a subsequent transaction. The operations further include transmitting a confirmation to the transaction terminal over the network via the network circuit.

### BRIEF DESCRIPTION OF THE FIGURES

FIG. 1 is a block diagram illustrating a privacy shield transaction system, according to an example embodiment.

FIG. 2 is a block diagram illustrating an example embodiment of the privacy shield transaction system of FIG. 1.

FIG. 3 is a depiction of a user interface for managing privacy shield transaction data, according to an example embodiment.

FIG. 4 is a depiction of a user interface for managing privacy shield transaction data, according to another example embodiment.

FIG. 5 is a flowchart of a method of authorizing a transaction request, according to an example embodiment.

### DETAILED DESCRIPTION

Embodiments of systems and methods of generating a user alias and authenticating payment transactions using the user alias are discussed below. A financial institution computer system generates a user alias for one-time-use or for multiple uses based on a request from a customer to conduct a transaction while keeping their identity or identifying information private. In various embodiments, transaction information is generated for the alias. The transaction information is a collection of payment information sufficient for a transacting party to complete a payment transaction. In some embodiments, the transaction information includes information not required by a financial institution for authenticating the transacting party but requested by a merchant during a transaction process. In some embodiments, the financial institution may create a user alias for a one-time-use, for multiple uses, for multiple uses with a particular merchant, or for purchases during a certain period of time when the user expects to conduct transactions where they will have privacy concerns. As such, a non-authorized user in possession of a user alias (e.g., a payment card account number, customer name, card security code, birthday, etc.) is not able to make fraudulent transactions, use the user alias for purposes of identity theft, or exploit the user's actual information for other purposes (e.g., mailing lists, customer information databases, etc.).

The embodiments and implementations of the systems and methods disclosed herein improve current transaction systems and computing systems for authenticating payment transactions by generating aliases for one-time-use or for multiple uses so that customers may conducts transactions while keeping their identity or identifying information private. These systems, methods, and computer implementations improve customer privacy when transacting with merchants that require personal information by keeping a user's true identity from a merchant while still providing identifying information to a merchant, even though the identifying information provided to the merchant may not be the user's real information, thereby providing improvements to the fields of authentication, information privacy, and information security. As such, the systems, methods, and computer implementations disclosed herein improve the functioning of transaction systems and computing systems for authenticating payment transactions by providing functionalities that are novel and non-obvious improvement over current systems.

The embodiments discussed herein may be relevant to any of a variety of circumstances where an exchange of authenticated payment credentials may be useful. For example, in one embodiment, user alias information may be used in the context of a purchase transaction at a brick and mortar retail establishment. In some embodiments, user alias information may be used in the context of electronic payment transactions (e.g., online shopping, mobile wallet transactions, person-to-person (“P2P”) transactions, etc.).

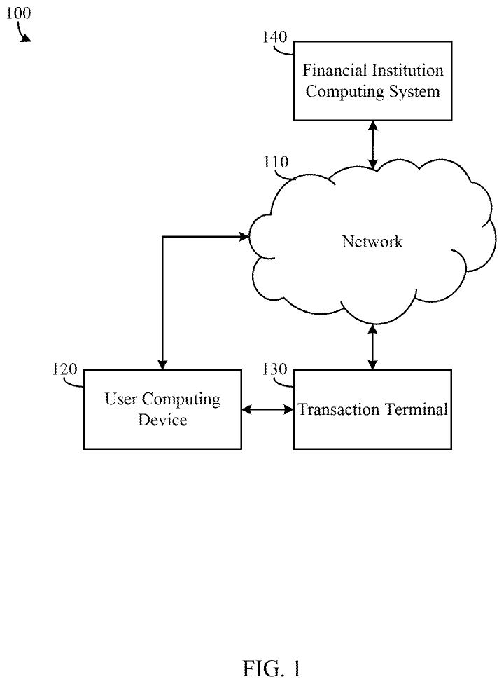

Referring to FIG. 1, a block diagram illustrating a privacy shield transaction system 100 is shown according to an example embodiment. The privacy shield transaction system 100 includes a user computing device 120, a transaction terminal 130, and a financial institution computing system 140. Various components of the system 100 may be configured to communicate with each other over a network 110. The network 110 is a data exchange medium, which may include wireless networks (e.g., cellular networks, Bluetooth®, WiFi, Zigbee®, etc.), wired networks (e.g., Ethernet, DSL, cable, fiber-based, etc.), or a combination thereof. In some embodiments, the network 110 includes the internet.

The user computing device 120 is a computing system associated with an authorized user of one or more financial accounts at the financial institution. The user computing device 120 includes one or more processors and non-transitory storage mediums housing one or more logics configured to enable the user computing device 120 to exchange data over the network 110, execute software applications, access websites, generate graphical user interfaces, and perform other similar functionalities. Examples of the user computing device 120 include a personal computer such as a desktop or laptop computer, smartphones, tablets, wearable computing devices such as smartwatches, and the like. In some embodiments, the user computing device 120 is or includes a smart payment card configured to display user alias information on the card. For example, the smart payment card may approximately have the form factor of a traditional credit card (e.g., 75 mm<length<95 mm; 45 mm<width<60 mm; preferably, length=85.6 mm, width=53.98 mm) but may have a processor, memory, and a display (e.g., utilizing E Ink technology). The smart card may be configured to display a variety of names, credit card numbers, and other user information including the user alias information. In some embodiments, the user computing device 120 may communicate with an additional device used to authenticate the user such as a smartwatch, a pedometer, a key fob, and the like. As such, the user computing device 120 may be configured to cooperate with the additional device to assemble and transmit transaction information that is ultimately received at the financial institution computing system 140.

The user computing device 120 is configured to communicate with the financial institution computing system 140 via the network 110 to exchange information. The user computing device 120 may be configured to authenticate the user of the user computing device 120 before transmitting information to the financial institution computing system 140. For example, the user computing device 120 may require the user to input a password, answer a security question, and provide a voice sample, finger print scan, face scan, or retinal scan before transmitting information to the financial institution computing system 140.

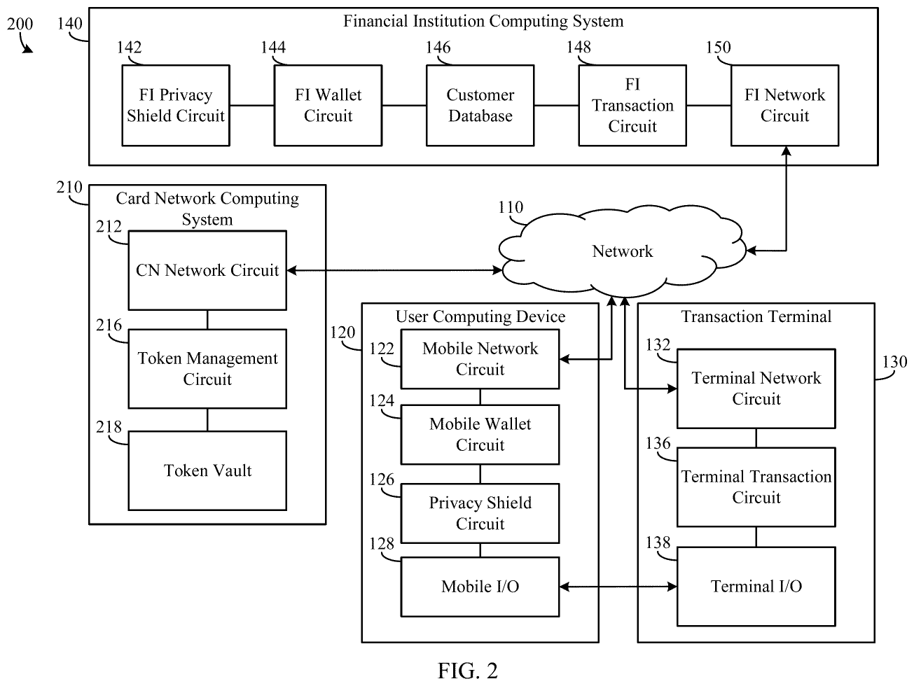

In some embodiments, the user computing device 120 is configured to manage at least one payment credential corresponding to a method of payment associated with the user. For example, the user computing device 120 may include one or more circuits configured to provide the user with a mobile wallet functionality, as discussed in more detail below with respect to FIG. 2. In some embodiments, in assembling transaction information, the mobile device includes payment credentials corresponding to a method of payment. In some embodiments, the same transaction information is provided to a merchant, but the transaction information is aliased (e.g., alias name, alias phone number, alias email address, etc.). The user computing device 120 may then transmit the transaction information to the transaction terminal 130.

The transaction terminal 130 is a computing system associated with an individual or entity with whom a user seeks to transact (e.g., merchants, service providers, etc.). The transaction terminal 130 is configured to receive transaction information from the user computing device 120 and create a transaction request that is transmitted to the financial institution computing system 140. The transaction request may be a request for the financial institution computing system 140 to withdraw a designated sum of funds from a financial account corresponding to the transaction information and deposit the designated sum of funds into an account associated with the requesting party (e.g., an individual or entity associated with the transaction terminal 130). The transaction request may be a request for the financial institution computing system 140 to debit a financial account corresponding to the transaction information and credit an account associated with the requesting party. For example, the transaction terminal 130 may include merchant point of sale terminals, ATMs, one or more servers configured to process online or P2P transactions, and so on.

In some embodiments, a transaction request may be generated by the user computing device 120. In this embodiment, the customer may use the user computing device 120 to “push” the transaction request to the financial institution computing system 140, in contrast to embodiments where the transaction terminal 130 “pulls” transaction information from the user computing device 120. In this embodiment, the user computing device 120 is configured to assemble transaction information, generate transaction requests, and transmit transaction requests to the financial institution computing system 140. The transaction requests may, for example, be made in the context of person-to-person (“P2P”) transactions (e.g., via the clearXchange™ network) where customers of a first financial institution (e.g., having an account associated with the financial institution computing system 140) may transfer funds to accounts of recipients at the first financial institution or at a second financial institution. The financial institution computing system 140 may be configured to receive a P2P transaction request from the user computing device 120, debit an account of a corresponding customer, and credit an account of an identified recipient associated with the recipient computing device.

The financial institution computing system 140 is a computing system at a financial institution that is capable of maintaining customer accounts (e.g., payment card accounts) and databases of customer information. The financial institution may include commercial or private banks, credit unions, investment brokerages, or the like. In response to a received transaction request, the financial institution computing system 140 may be configured to authorize a transaction request (e.g., determining whether the identified financial account contains sufficient funds, and transferring the designated sum of funds to an identified account). The financial institution computing system 140 may be configured to transmit a message back to the transaction terminal 130 indicating whether the transaction request was approved or denied.

In some embodiments, a user may wish to make a privacy shield transaction because they do not want the other party to a transaction to know their true identity or the user may not feel comfortable providing the other party with their true identity for a variety of reasons. For example, in some instances, a user may wish to make a privacy shield transaction if the user is purchasing an item from an online retailor and is not certain where their information may be routed (e.g., countries known for identify theft), who will have access to their information (e.g., an unscrupulous merchant), or whether their information will be stored and processed by the merchant in an unsecure way (e.g., vulnerable to cyber-attacks), and so on. Sometimes, a user may not have concerns that their information will be used for fraud, but nonetheless wishes to not be contacted by the merchant and to remain off of mailing lists, such as promotional emails or other advertising campaigns. In some cases, a user may wish to not provide their actual identity to a merchant when purchasing a personal item such as medicine or medical equipment, and the like. A user wishing to make a purchase in a brick-and-mortar store may have the similar concerns. While the present application refers to a transaction or multiple transactions with respect to a financial institution, it will be appreciated that the term “transaction” is used in its broadest sense and does not necessarily require an exchange of goods or monetary consideration. For example, the term transaction should be understood to encompass a variety of situations, including registering for websites, surveys, and the like.

In some embodiments, in operation, a user wishing to make a privacy shield transaction operates the user computing device 120 to send a privacy shield request to the financial institution computing system 140. In some embodiments, the user allows the user computing device 120 to communicate with the transaction terminal 130 (e.g., by bringing the user computing device 120 within range of an NFC reader at the transaction terminal 130). In some embodiments, while in communication with the transaction terminal 130, the user computing device 120 may also receive a user alias from the financial institution computing system 140. In some embodiments, the user reads the user alias off the screen of the user computing device 120 and manually enters the user alias information into website fields. In some embodiments, the user computing device 120 auto-populates website fields with the user alias information. For example, the privacy shield circuit 126 may be configured to scan a website for a “name” field, then auto-populate the field with the alias name. The privacy shield circuit 126 may cause the user alias information and the website URL to be stored for use in future transactions. The transaction terminal 130 generates a transaction request that includes the transaction information, and transmits the transaction request to the financial institution computing system 140 over the network 110. The financial institution computing system 140 receives and authenticates the transaction request, performs any of a variety of other financial and/or fraud checks (e.g., available balances, transaction histories, personal identification number (“PIN”) verification, etc.), and authorizes the requested transaction. The financial institution computing system 140 then transmits a confirmation back to the transaction terminal 130 over the network 110. Additional details and functions of the system 100 are discussed below.

Referring now to FIG. 2, a block diagram illustrating an example embodiment of the privacy shield transaction system of FIG. 1 is shown including example embodiments of the user computing device 120, the transaction terminal 130, and the financial institution computing system 140 of FIG. 1.

The system 200 further includes a card network computing system 210. The card network computing system 210 is a computing system associated with a card network. Examples of card networks include Visa®, MasterCard®, etc. The card network computing system 210 performs operations associated with the generation and issuance of payment card tokens. Payment card tokens are surrogate values that replace the primary account number (“PAN”) associated with a payment card, such as a credit card, debit card, ATM card, stored value card, etc. Payment card tokens may pass basic validation rules of an account number. Hence, in the case of a debit card, the payment card token for a given debit card “looks like” a real debit card number (e.g., a sixteen-digit number), but in fact is only a token. As part of a token generation process, steps are taken such that the generated payment card token does not have the same value as or otherwise conflicts with a real or alias PAN (e.g., a real debit card number or a debit card number that is part of a user alias). A given payment card token may be provisioned to various locations for use in various types of scenarios, including ATMs for performing various financial operations, storage at a mobile device (e.g., a smartphone) for in-person or on-line transactions with a merchant, and so on.

The card network computing system 210 includes a card network (“CN”) computing system network circuit 212, a token management circuit 216, and a token vault 218. The CN network circuit 212 enables the card network computing system 210 to exchange data over the network 110. As such, the CN network circuit 212 allows the card network computing system 210 to exchange data to remote computing devices (e.g., the user computing device 120, the transaction terminal 130, the financial institution computing system 140, etc.).

The token management circuit 216 is configured to provision and manage tokens. In one aspect, the token management circuit 216 may generate a new unique code to be provisioned as a token, associate the token with a PAN, and store corresponding mapping data in the token vault 218. In another aspect, the token management circuit 216 may be able to replace tokens as well as activate and deactivate tokens, and update the token vault 218 accordingly. The token management circuit 216 may also be configured to associate permissions with each token, thereby allowing or disallowing the transmission or use of data associated with a given token (e.g., a user alias). The token management circuit 216 may also cause one or more tokens to be disposed on the user computing device 120, for example as discussed with respect to the mobile wallet circuit 124 below.

The token vault 218 is a storage medium maintaining established payment card tokens-to-PAN mapping data. The token vault 218 may include non-transient data storage mediums (e.g., local disc or flash-based hard drives, local network servers, and the like) or remote data storage facilities (e.g., cloud servers).

The user computing device 120 includes a mobile network circuit 122 enabling the user computing device 120 to exchange data over the network 110, mobile wallet circuit 124, a privacy shield circuit 126, and a mobile input/output device (“I/O”) 128. The mobile I/O 128 includes hardware and associated logics configured to enable the user computing device 120 to exchange information with a user and the transaction terminal 130 (e.g., via a corresponding terminal I/O 138, as discussed below). An input aspect of the mobile I/O 128 allows the user to provide information to the user computing device 120, and may include, for example, a mechanical keyboard, a touchscreen, a microphone, a camera, a fingerprint scanner, any user input device engageable to the user computing device 120 via a USB, serial cable, Ethernet cable, and so on. An output aspect of the mobile I/O 128 allows the user to receive information from the user computing device 120, and may include, for example, a digital display, a speaker, illuminating icons, LEDs, and so on. Further, the mobile I/O 128 may be configured to include assemblies that serve both input and output functions, allowing the financial institution computing system 140 and the transaction terminal 130 to exchange information with the user computing device 120. Such assemblies include, for example, radio frequency transceivers (e.g., RF or NFC-based transceivers) and other short range wireless transceivers (e.g., Bluetooth™, laser-based data transmitters, etc.).

The mobile wallet circuit 124 is a circuit configured to provide a user with a mobile wallet functionality. As used herein, each circuit may include program logic executable by hardware disposed at a computing system to implement at least some of the respective functions described herein. For example, in order to make the mobile wallet circuit 124, a provider (e.g., a software developer or publisher, or the financial entity itself) may make a software application available to be placed on the user computing device 120. A software developer may make the software application available to be downloaded (e.g., via the developer's website, via a digital marketplace, an app store, or in another manner). Responsive to a user selection of an appropriate link, the software application may be transmitted to the user computing device 120 and cause itself to be installed on the user computing device 120. Installation of the software application creates the mobile wallet circuit 124 on the user computing device 120. Specifically, after installation, the thus-modified user computing device 120 includes the mobile wallet circuit 124 (e.g., embodied as a processor and instructions stored in non-transitory memory that are executed by the processor, along with other hardware and associated logics depending on operations performed by a given circuit). Other circuits discussed herein may be implemented in a similar fashion, or in other ways (e.g., via a portal to a remote computing system configured to perform functions described herein, via one or more software plugins, etc.).

The mobile wallet circuit 124 may provide an interface configured to receive and display mobile web pages (e.g., web pages provided on the mobile I/O 128 prompting the user to provide information to create an account, web pages displaying account balance information, past transactions, user aliases, a history of user aliases previously used, and so on) received from a mobile wallet bank computer system (e.g., an FI wallet circuit 144 at the financial institution computing system 140 as discussed below, or a third party wallet provider such as ApplePay™ or Android Pay™) over the network 110 via the mobile network circuit 122.

While setting up a mobile wallet account, the mobile wallet circuit 124 may receive, organize, and store payment credentials (e.g., payment tokens) from a payment card (e.g., from local storage disposed on a credit card, debit card, gift card, etc., for example, via smart card functions provided by Visa payWave™, Mastercard PayPass™, and American Express ExpressPay™) or the card network computing system 210 over the network 110. The mobile wallet circuit 124 may then allow users to choose any one of the accounts (e.g., by selecting a corresponding payment token) for transferring funds, for example, to a merchant for goods or services. A user may select an account that the mobile wallet circuit 124 will use to make payments by default. The user may alternatively use account selection logic at the mobile wallet circuit 124 to select a specific account to use for each transaction. In some embodiments, the account used to make purchases may be selected further based on the use of a user alias as will be discussed in more detail below.

In some embodiments, the mobile wallet circuit 124 is configured to cooperate with the privacy shield circuit 126 and the mobile I/O 128 to assemble transaction information. For example, prior to a transaction, the mobile wallet circuit 124 may be configured to authenticate the user computing device 120. The mobile wallet circuit 124 may then retrieve a user alias via the mobile I/O 128, and assemble transaction information to include the user alias. The mobile wallet circuit 124 may subsequently transmit the transaction information to the transaction terminal 130 via the mobile I/O 128.

The privacy shield circuit 126 is a circuit configured to provide a user the ability to carry out transactions using a user alias so that no actual identifying information of the user is provided to the other party of the transaction apart from the user alias. The privacy shield circuit 126 is configured to receive, generate, organize, store, and compare stored user aliases with information contained in transaction information received from the transaction terminal 130. The privacy shield circuit 126 is configured to cooperate with the mobile I/O 128 to permit a user to create custom user aliases and to view and manage currently existing user aliases. The privacy shield circuit 126 is configured to communicate with the financial institution computing system 140 via the network 110 as will be discussed further below. In some embodiments, the privacy shield circuit 126 is configured to request a one-time-use user alias that expires based on completion of a transaction. For example, in one embodiment, a user requests a user alias from the financial institution computing system 140 to conduct a one-time transaction such that the user alias expires based on the completion of the transaction. In some embodiments, the user alias is stored for future use at the same merchant.

The transaction terminal 130 includes a terminal network circuit 132 enabling the transaction terminal 130 to exchange data over the network 110, a terminal transaction circuit 136, and a terminal I/O 138. Similar to the mobile I/O 128, the terminal I/O 138 includes hardware and associated logics configured to enable the transaction terminal 130 to exchange information with a user, the user computing device 120 (e.g., via corresponding hardware and logics at the mobile I/O 128), and a terminal attendant (e.g., a store clerk), if any. The terminal I/O 138 may include any of the input, output, and input/output functionalities discussed with respect to the mobile I/O 128, above.

The terminal transaction circuit 136 is configured to receive transaction information (e.g., including a payment token) from the user computing device 120 via the terminal I/O 138, and assemble corresponding transaction requests. In some embodiments, the terminal transaction circuit 136 includes or is associated with computing systems configured to provide supplemental transaction information, for example product prices, inventory information, shipping or ordering information, etc. The terminal transaction circuit 136 determines an amount for a payment transaction, bundles the price with the transaction information to make a transaction request, and transmits the transaction request to the financial institution computing system 140 over the network 110 via the terminal network circuit 132.

The financial institution computing system 140 includes a financial institution (“FI”) privacy shield circuit 142, an FI wallet circuit 144, a customer database 146, an FI transaction circuit 148, and an FI network circuit 150 enabling the financial institution computing system 140 to exchange data over the network 110.

The customer database 146 allows the financial institution computing system 140 to retrievably store customer information relating to the various operations discussed herein, and may include non-transient data storage mediums (e.g., local disc or flash-based hard drives, local network servers, and the like) or remote data storage facilities (e.g., cloud servers). The customer database 146 includes personal customer information (e.g., names, addresses, phone numbers, and so on), identification information (e.g., driver's license numbers, standard biometric data, and so on), and customer financial information (e.g., token information, identification code information, identification code algorithms, account numbers, account balances, available credit, credit history, transaction histories, and so on). The customer database 146 includes information relating to a plurality of users who are authorized to make transactions from a plurality of financial accounts (e.g., credit card accounts, checking accounts, etc.). Authorized users may include account owners, or other individuals designated as authorized users by a respective account owner. The customer database 146 further includes user aliases corresponding to the plurality of financial accounts and the plurality of authorized users.

The FI privacy shield circuit 142 enables the financial institution computing system 140 to generate user aliases and cooperates with the FI wallet circuit 144 and FI transaction circuit 148 to authorize transactions where a user alias is used in lieu of actual identifying information of an authorized user of an account of the financial institution. The FI privacy shield circuit 142 is configured to receive information over the network 110 via the FI network circuit 150. In some embodiments, the FI privacy shield circuit 142 receives a privacy shield request from an authorized user of a financial account via the user computing device 120. The FI privacy shield circuit 142 is further configured to transmit the generated user alias to the user computing device 120 over the network 110 via the FI network circuit 150. In some embodiments, transmitting the user alias to the user computing device 120 causes a display screen of the user computing device 120 to display the user alias.

The FI privacy shield circuit 142 is configured to generate a user alias for any authorized user of the financial account. In some embodiments, the user alias is generated based on an algorithm stored in the FI privacy shield circuit 142. The algorithm may be based on the user's location. In some embodiments the algorithm is based on the user's location at the time the request for a user alias is received by the privacy shield circuit 142 or based on the location of a particular merchant if specified by the request. In some embodiments, the user alias is generated using a database containing lists of various information, such as names, addresses, cities, phone numbers, email addresses, birth dates, and so on. In some embodiments, the FI privacy shield circuit 142 may be configured to generate the user alias based on an age range, region, physical disposition, or ethnicity specified by the user. In some embodiments, the FI privacy shied circuit 142 compares the generated alias information against real identifying information associated with another user (e.g., another user's actual name, address, phone number, etc.) to ensure the user does not provide a merchant with someone else's real identifying information.

In some embodiments, the FI privacy shield circuit 142 is configured to provide particular types of alias information based on particular types of alias information requested by the user in the privacy shield request. For example, the user alias may include information about the user that is inaccurate (i.e., not the user's actual information) but known to be inaccurate by the financial institution computing system 140. In some embodiments, for example, the user alias includes alias transaction information (e.g., information needed or typically requested to carry out a transaction) including at least one of an alias card number, an alias card security code, and an alias card expiration date, but the alias card number, alias card security code, and alias card expiration date do not include an actual card number, card security code, or card expiration date of the user. In some embodiments, for example, the user alias includes alias personal information (e.g., information about the user's person) including at least one of an alias user name, an alias user address, an alias user birth date, an alias user phone number, and an alias user email address, but the alias user name, the alias user address, the alias user birth date, the alias user phone number, and the alias user email address do not include an actual name, address, birth date, phone number, or email address of the user. In some embodiments, for example, the user address includes at least one of an alias street address, an alias city, an alias state or province, an alias country, and an alias ZIP or postal code. In some embodiments, for example, the user alias includes alias merchant-required information (e.g., discretionary information required by a merchant but not required by the financial institution computing system 140 to authenticate a transaction).

The FI privacy shield circuit 142 is configured to associate the generated user alias with the financial account of the authorized user in the customer database 146 for use in conjunction with a subsequent transaction. Use of the user alias in conjunction with a subsequent transaction includes using the user alias for at least one of an authentication procedure and providing requested information to a merchant. In some embodiments, a user may request a user alias prior to making a transaction. For example, the user may request a user alias before entering a brick and mortar store so that the user can memorize their alias name, alias phone number, alias area code, and so on, for the privacy shield transaction. In another example, the user may request a user alias before carrying out an online transaction so that they may provide the alias information in response to being presented with forms, a user account registration prompt, or discretionary fields to complete as requested or required by the online merchant. In some embodiments, the FI privacy shield circuit 142 is configured to generate a user alias name for a user but not a user alias address based on the privacy shield transaction request specifying that the item to be purchased will be shipped to the residence of the user.

In some embodiments, the privacy shield request specifies a particular merchant for a subsequent transaction and the FI privacy shield circuit 142 is configured to associate the generated user alias with the particular merchant in the customer database 146. For example, a user alias may be associated with a particular merchant such that a transaction request containing information from the user alias will only be authorized based on the transaction request originating with or otherwise being associated with the particular merchant. In some embodiments, multiple user aliases may be associated with a user's account in the customer database 146. For example, a first, second, and third user alias may be associated with a single user's account and further associated with a first, second, and third merchant, respectively, such that a single user can use a different user alias to authenticate separate transactions with different merchants.

In some embodiments, the user alias may expire after the user alias is used a certain number of times to authenticate transactions. In some embodiments, the user alias is a one-time-use user alias that expires based on a completion of a single transaction. In other embodiments, the user alias may be used multiple times to authenticate transactions. Multiple-use user aliases may be used to authenticate transactions for a particular merchant or for any number of different merchants. In some embodiments, a user alias may expire after a predetermined time period. For example, a one-time-use user alias may be used to authenticate a transaction that must occur within a day of requesting the user alias. In some embodiments, the user alias may expire upon the completion of a transaction and the completion of the transaction may be based on at least one of the transmission of a confirmation and an authorization of the transaction request. In another example, a multiple-use user alias may be used to authenticate numerous transactions during a predetermined time period (e.g., an hour, a few days, a year, etc.). In another example, a multiple-use user alias may be used to authenticate numerous transactions over an indefinite time period (e.g., a time period without a predetermined expiration date). For example, a multiple-use user alias may be used to authenticate a recurring transaction between an authorized user associated with the user alias and a merchant.

In some embodiments, the FI privacy shield circuit 142 is configured to determine the location of the user computing device 120 at the time of a mobile wallet transaction to ensure that the user provides the same user alias that was previously provided to a particular merchant at or near the location. For example, the FI privacy shield circuit 142 may be configured to prompt the user via the mobile I/O 128 to use a first user alias of a plurality of user aliases associated with the user based on the user being at a location of a merchant where the first user alias was previously used. In another example, the privacy shield circuit 126 is configured to cooperate with the FI privacy shield circuit 142 to automatically determine which user alias should be used with a particular merchant based on a transaction history log associating a particular user alias with a particular merchant. For example, the FI privacy shield circuit 142 may be configured such that a user wishing to make a return at a merchant will be able to provide the same information that was used to conduct the original transaction. In another example, user preferences stored by the merchant may also be utilized as part of the transaction. For example, for a user that stayed at a hotel, the preferences of the user (e.g., two double beds, non-smoking room) may be retrieved and utilized.

In some embodiments, the FI wallet circuit 144 enables or otherwise supplements the operation of the mobile wallet circuit 124. In some embodiments, the FI wallet circuit 144 is configured to communicate with the mobile wallet circuit 124 over the network 110 (e.g., via respective network circuits 122, 150). In one embodiment, the FI wallet circuit 144 operates as an intermediary between the user computing device 120 and the card network computing system 210. For example, a user may establish the mobile wallet circuit 124 on the user computing device 120 and set up a mobile wallet account. The user may then manually provide a PAN to the mobile wallet circuit 124 via the mobile I/O 128, and the mobile wallet circuit 124 may transmit the PAN to the FI wallet circuit 144 over the network 110 (e.g., via respective network circuits 212, 150). The wallet circuit 144 may then route the PAN to the token management circuit 216 over the network 110 for tokenization, receive a payment token in return, and transmit the payment token back to the mobile wallet circuit 124. The mobile wallet circuit 124 may then allow the user to use the payment token to create transaction information to include a user alias. The FI wallet circuit 144 may also cooperate with the mobile wallet circuit 124 and the token management circuit 216 to manage token permissions, token life cycles, etc.

The FI transaction circuit 148 is configured to facilitate transactions involving the FI privacy shield circuit 142. The FI transaction circuit 148 may receive a transaction request from the transaction terminal 130 over the network 110 via the FI network circuit 150. In some embodiments, the FI transaction circuit 148 receives the transaction request from the card network computing system 210 (e.g., where payment tokens are used). In one aspect, the FI transaction circuit 148 authenticates the user using user alias information included in the transaction request. In one embodiment, the FI transaction circuit 148 looks up the user alias information in the customer database 146 and confirms whether the user alias information is associated with an authorized user of the user computing device 120. If known user alias information matches the user alias information in the transaction request, the FI transaction circuit 148 may authenticate the transaction request. In other words, rather than matching the customer's real name to authenticate the transaction, the transaction is authenticated based on there being a match between, for example, the alias name provided to the customer via computing device 120 and the alias name provided by the transaction terminal 130 to the FI computing system 140. In some embodiments, the FI transaction circuit 148 may be configured to request additional authentication information from the user (e.g., a PIN, answers to one or more security questions, etc.).

In another aspect, the FI transaction circuit 148 may perform a series of checks separate from and in addition to identifying the user alias and authorizing the transaction request. The FI transaction circuit 148 may perform one or more fraud checks (e.g., comparing a location and time of a previous transaction with the location and time of the pending transaction request). In addition, the FI transaction circuit 148 may determine whether the transaction request may properly be completed, for example, determining whether the financial account specified in the transaction request contains sufficient funds to cover the purchase price. In one embodiment, if the transaction request passes a plurality of fraud checks and the underlying transaction may properly be completed, the FI transaction circuit 148 authorizes and completes the transaction request.

In operation according to one embodiment, a user sets up and configures the mobile wallet circuit 124 on the user computing device 120 and uses the mobile wallet circuit 124 in cooperation with the FI wallet circuit 144 to register at least one approved method of payment at the financial institution computing system 140. The user may approach the transaction terminal 130 to purchase a good or service, and tap the user computing device 120 against the terminal I/O 138. The mobile wallet circuit 124 may then prepare transaction information and a payment token. The transaction information may then be transmitted from the mobile I/O 128 to the terminal I/O 138.

The terminal transaction circuit 136 receives and bundles the transaction information with a purchase price to generate a transaction request. The terminal transaction circuit 136 then transmits the transaction request to the card network computing system 210 over the network 110 via the terminal network circuit 132. The token management circuit 216 receives the transaction request and cooperates with the token vault 218 to detokenize the payment token into a PAN. The token management circuit 216 then includes detokenized payment token information in the transaction request, and transmits the transaction request to the financial institution computing system 140 over the network 110 via the CN network circuit 212.

The FI transaction circuit 148 at the financial institution computing system 140 receives the transaction request via the FI network circuit 150. The FI transaction circuit 148 cooperates with the customer database 146 and the FI privacy shield circuit 142 to authenticate the transaction request using the included user alias, performs a plurality of fraud checks, and determines whether the requested transaction may properly be completed. The FI transaction circuit 148 authorizes the requested transaction, and transmits a confirmation to the terminal transaction circuit 136 over the network 110. The terminal transaction circuit 136 may cause the terminal I/O 138 to provide the user or a clerk with a visual representation of the confirmation (e.g., a screen on a display, a printed receipt, etc.).

In some embodiments, an entity such as a person or company (e.g., a financial institution associated with the financial institution computing system 140) is authorized to act as an agent of the customer. In this regard, the customer may notify the authorized entity to purchase goods or services from a merchant on the customer's behalf using identifying information and/or payment information of the authorized entity to complete the transaction. In this way, the authorized entity acts as a privacy shield for the customer as identifying information and/or payment information of the customer is not exchanged with the merchant. In the context of purchasing goods, the authorized entity may receive the goods and hold them for the customer to later retrieve, or the authorized entity may ship the goods to the customer, etc. For example, in response to receiving instructions from a customer via the user computing device 120 to purchase an item for the customer, the authorized entity purchases the item from a merchant using transaction information associated with the authorized entity, and stores the item for the customer at a holding facility for retrieval by the customer (e.g., in a locker, at a lockbox facility, etc.).

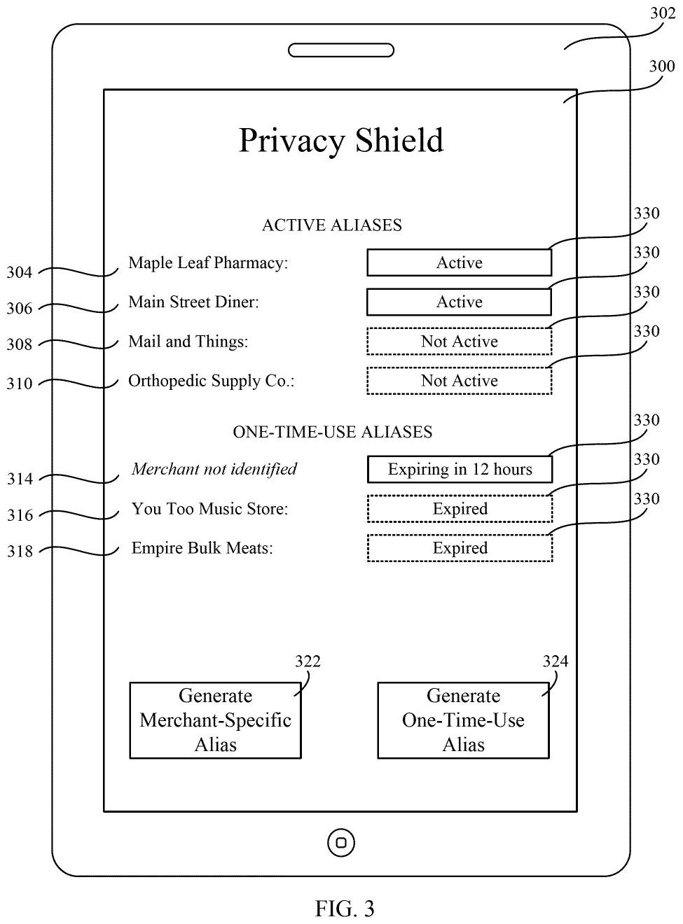

Referring now to FIG. 3, a depiction of a user interface 300 for managing privacy shield transaction data on a mobile device 302 is shown according to an example embodiment. The graphical user interface 300 includes a plurality of notices and fields directed to allow a user to enable the use of user aliases to protect their true identity. The user interface 300 includes a list of active aliases (i.e., 304, 306, 308, 310) and a list of one-time-use aliases (i.e., 314, 316, 318) associated with a financial account of the user and a list of status identifiers 330 associated with the list of active aliases and the list of one-time-use aliases. The user interface 300 also includes a first interactive trigger 322 for generating a merchant-specific alias and a second interactive trigger 324 for generating a one-time-use alias.

The status identifiers 330 are associated with current statuses of various user aliases associated with the user of the mobile device 302. In one embodiment, the “Active” status results from the user requesting a multiple-use alias for use with a specific merchant (e.g., by interacting with the first interactive trigger 322), the FI privacy shield circuit 142 generating a user alias associated with a particular merchant, associating the user alias with a financial account in the customer database 146 for use in conjunction with a subsequent transaction, and transmitting the user alias to the user computing device 120 over the network 110 via the network circuit 150. In one embodiment, the “Not Active” status results from the associated user alias expiring due to expiration of a predetermined time period, a completion of a predetermined number of transactions, deactivation by the user, etc. In some embodiments, a user may be able to navigate the user interface 300 to access “Not Active” user alias information, for example, in case the user makes a follow-up transaction with the same merchant or decides to return a previously purchased item to a merchant from which it was bought using the user alias.

In one embodiment, the “Expiring in 12 hours” status results from the user requesting a one-time-use alias (e.g., by interacting with the second interactive trigger 324), the FI privacy shield circuit 142 generating a user alias, associating the user alias with a financial account in the customer database 146 for use in conjunction with a subsequent transaction, and transmitting the user alias to the user computing device 120 over the network 110 via the network circuit 150. In some cases, the one-time-use alias may be associated with a particular merchant before carrying out a transaction with the merchant or the one-time-use alias may not be associated with any particular merchant and the merchant may remain unidentified until a purchase is complete. As shown in FIG. 3, a first one-time-use alias 314 is not currently associated with a particular merchant and the alias is set to expire in twelve hours. In some embodiments, a one-time-use alias may not expire except for upon use of the one-time-use alias by the user in a privacy shield transaction. The “Expired” status results from the one-time-use aliases being used one time in a privacy shield transaction. In some embodiments, a user may be able to navigate the user interface 300 to access “Expired” user alias information and transaction history information.

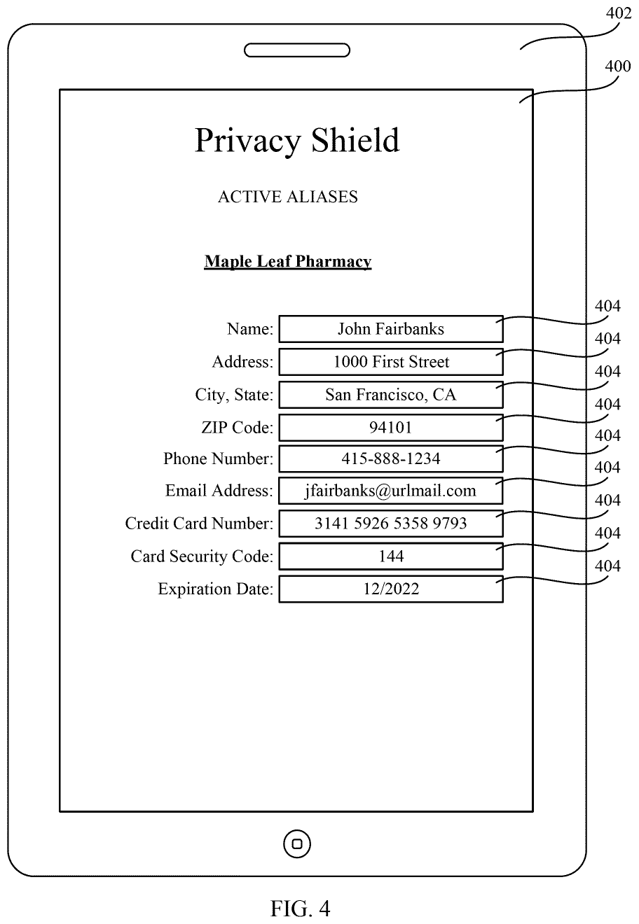

Referring now to FIG. 4, a depiction of a user interface 400 for managing privacy shield transaction data on a mobile device 402 is shown according to another example embodiment. The graphical user interface 400 includes a plurality of fields 404 including user alias information for allowing a user to review the user alias information and enter the user alias information as part of a transaction. For example, when making a purchase from an online retailor, the user may be required to enter their transaction information (e.g., credit card number, card security code, and card expiration date) and personal information (e.g., name, address, city, state, ZIP code, phone number, and email address) as part of an authentication process or as part of a personal data gathering process of the online retailor. By reviewing the user alias information on the user interface 400 and entering the user alias information into the appropriate fields on a website's order pages, a user is able to maintain their privacy and prevent the retailor from learning their true identity, while still enabling the user to conduct a transaction with the retailor. In some embodiments, the user may edit the user alias or create their own user alias for use in privacy shield transactions.

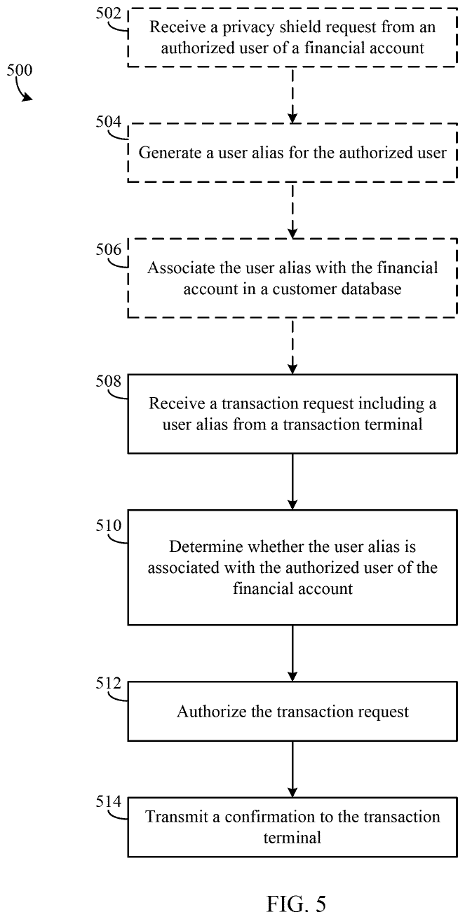

Referring now to FIG. 5, a flowchart of a method 500 of authorizing a transaction request is shown according to an example embodiment. The method 500 may be performed by processing and storage hardware on a financial institution computing system (e.g., financial institution computing system 140), as executed by one or more logics comprising one or more software applications configured to perform the functions described below.

At step 502, the financial institution computing system 140 receives, by the FI privacy shield circuit 142 over a network 110 via the FI network circuit 150, a privacy shield request from an authorized user of a financial account via a computing device, such as user computing device 120. In some embodiments, the request specifies whether the user wishes to make a one-time transaction or whether the user would like to use any alias information for multiple transactions. The request may also specify a particular merchant that the user plans to transact with.

At step 504, after receiving the privacy shield request, the financial institution computing system 140 generates, by the FI privacy shield circuit 142, a user alias for the authorized user of the financial account. In some embodiments, the FI privacy shield circuit 142 generates a one-time-use or multiple-use user alias. In some embodiments, the user alias may be associated with a particular merchant. In some embodiments, the FI privacy shield circuit 142 may cause the user alias to be transmitted to the user computing device 120 over the network 110 via the FI network circuit 150.

At step 506, the financial institution computing system 140 associates, by the FI privacy shield circuit 142, the user alias with the financial account in the customer database 146. For example, in some embodiments, the user alias is associated with a financial account of the user. In some embodiments, a single financial account may be associated with a plurality of user aliases, including one-time-use user aliases and multiple-use user aliases. In some embodiments, a particular user alias may be associated with a particular merchant or a plurality of merchants in a certain region or geographic area.

At step 508, the financial institution computing system 140 receives, by the FI privacy shield circuit 142 over a network 110 via the FI network circuit 150, a transaction request from the transaction terminal 130. The transaction request may include at least part of a user alias provided by the user to the transaction terminal 130. In some embodiments, the financial institution computing system 140 receives the transaction request from the transaction terminal 130. In some embodiments, the FI privacy shield circuit 142 or the financial institution computing system 140 provides an indication to the transaction terminal 130 that a user alias is being used but that the user alias can be used to authenticate the transaction. In some embodiments, the FI privacy shield circuit 142 or the financial institution computing system 140 provides an indication that part of the user's actual information may be provided to the merchant in exchange for the merchant offering the user an incentive (e.g., a promotion, a discount, a free item, etc.).

At step 510, the financial institution computing system 140 compares, by the FI privacy shield circuit 142, at least part of the user alias to financial information stored in the customer database 146 storing financial information for a plurality of users to check the financial information for the alias information. The FI privacy shield circuit 142 determines whether the alias card number matches the alias information provided by a merchant.

At step 512, the financial institution computing system 140 authorizes, by the FI privacy shield circuit 142, the transaction request based on the at least part of the user alias received and information in the customer database 146. For example, if the alias card number matches the alias information provided by the merchant, the transaction is authorized. If the alias card number does not match the alias information provided by the merchant, the transaction may be declined. At step 514, the financial institution computing system 140 transmits, by the FI privacy shield circuit 142, a confirmation to the transaction terminal 130 over the network 110 via the FI network circuit 150.

The embodiments described herein have been described with reference to drawings. The drawings illustrate certain details of specific embodiments that implement the systems, methods, and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input device,” as described herein, may include any type of input device or input devices including, but not limited to, a keyboard, a keypad, a mouse, joystick, or other input devices capable of performing a similar function. Comparatively, the term “output device,” as described herein, may include any type of output device or output devices including, but not limited to, a computer monitor, printer, facsimile machine, or other output devices capable of performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps, and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described to explain the principals of the disclosure and its practical application to enable one skilled in the art to utilize the various embodiments and with various modifications as are suited to the particular use contemplated. Other substitutions, modifications, changes, and omissions may be made in the design, operating conditions, and arrangement of the embodiments without departing from the scope of the present disclosure as expressed in the appended claims.

1. A financial institution computing system, the system comprising:
a network circuit configured to enable the financial institution computing system to exchange information over a network;
a customer database configured to store financial information for a plurality of users; and
a privacy shield circuit configured to:
receive, over the network via the network circuit, a privacy shield request from an authorized user of a financial account via a user computing device, the privacy shield request comprising a location of the authorized user, and wherein the financial account is associated with a plurality of active user aliases, and wherein the authorized user comprises a true identity and true identifying information;
generate a first user alias for the authorized user of the financial account, the first user alias associated with a status identifier that includes at least a current status of the first user alias, and a geographic area for use in a number of subsequent privacy shield transaction requests, and wherein generating the first user alias is based on the location of the authorized user at a time of the privacy shield request, and wherein the first user alias expires based on a completion of the number of subsequent privacy shield transactions using the first user alias, and wherein generating the first user alias further comprises verifying that the first user alias does not match any set of true identifying information of a plurality of true identifying information associated with the user and other users stored in the customer database by comparing the first user alias with the sets of true identifying information of the plurality of true identifying information;
store the first user alias in the customer database for use in conjunction with the number of subsequent privacy shield transactions in the geographic area, wherein use of the first user alias in conjunction with the subsequent privacy shield transactions includes using the first user alias for at least one of an authentication procedure and providing requested information to a transaction terminal of a merchant;
associate the first user alias with the plurality of active user aliases associated with the financial account in the customer database, wherein each of the plurality of active user aliases comprise an alias identity and alias identifying information, and wherein the alias identity is different than and not associated with the true identify, and wherein the alias identifying information is different than and not associated with the true identifying information;
determine the user computing device is within the geographic area and at a merchant location where one of the plurality of active user aliases was previously used, wherein determining where one of the plurality of active user aliases was previously used is based on location data received from the user computing device and a transaction history log associated with the one of the plurality of active user aliases;
prompt, in response to determining the user computing device is within the geographic area, on a display of the user computing device, the authorized user to use a second user alias of the plurality of active user aliases, wherein the second user alias was previously used at the location of the merchant location;
receive, from a short range wireless transmission at the transaction terminal of the merchant, a privacy shield transaction request comprising the second user alias within the geographic area, wherein the privacy shield transaction request is requested by the user and the second user alias comprises corresponding alias identity and alias identifying information;
match the second user alias to the one of the plurality of active user aliases, wherein the second user alias is matched to the one of the plurality of active user aliases while maintaining the privacy of the true identity and the true identifying information of the authorized user by preventing the true identity and the true identifying information from being exposed to the merchant; and
authorize the transaction request based on the matching the second user alias with the one of the plurality of active user aliases.

2. The financial institution computing system of claim 1, further comprising a transaction circuit configured to:
in response to authorizing the privacy shield transaction request, transmit a confirmation to the transaction terminal over the network via the network circuit.

3. The financial institution computing system of claim 2, wherein the transaction circuit is configured to authorize the privacy shield transaction request based on the privacy shield transaction request being associated with the merchant.

4. The financial institution computing system of claim 2, wherein the first user alias is a one-time-use user alias that expires based on a completion of a transaction using the first user alias.

5. The financial institution computing system of claim 4, wherein the completion of the transaction using the first user alias is based on at least one of a transmission of a confirmation and an authorization of a transaction request associated with the transaction using the first user alias.

6. The financial institution computing system of claim 2, wherein the privacy shield circuit is further configured to associate the first user alias with a particular merchant.

7. The financial institution computing system of claim 1, wherein the alias identity and the alias identifying information of the second user alias includes alias transaction information including at least one of an alias card number, an alias card security code, and an alias card expiration date; and
wherein the alias transaction information does not include an actual card number, card security code, or card expiration date of the user.

8. The financial institution computing system of claim 1, wherein the first user alias includes alias personal information including at least one of an alias user name, an alias user address, an alias user birth date, an alias user phone number, and an alias user email address; and
wherein the alias personal information does not include an actual name, address, birth date, phone number, or email address of the user.

9. The financial institution computing system of claim 8, wherein the alias user address includes at least one of an alias street address, an alias city, an alias state or province, an alias country, and an alias ZIP or postal code.

10. The financial institution computing system of claim 1, wherein the privacy shield circuit is further configured to compare the generated first user alias with real identifying information associated with another user stored in the customer database, and wherein the generated first user alias does not include any real identifying information associated with another user.

11. The financial institution computing system of claim 1, wherein transmitting the second user alias to the user computing device causes a display screen of the user computing device to display the user alias.

12. The financial institution computing system of claim 1, wherein the privacy shield transaction request is received from the user computing device at a point of sale.

13. A method of authorizing a privacy shield transaction request performed by a financial institution computing system, the method comprising:
receiving, by a privacy shield circuit over a network via a network circuit, a privacy shield request from an authorized user of a financial account via a user computing device, the privacy shield request comprising a location of the authorized user, and wherein the financial account is associated with a plurality of active user aliases, and wherein the authorized user comprises a true identity and true identifying information;
generating, by the privacy shield circuit, a first user alias for the authorized user of the financial account, the first user alias associated with a status identifier that includes at least a current status of the first user alias, and a geographic area for use in a number of subsequent privacy shield transaction requests, and wherein generating the first user alias is based on the location of the authorized user at a time of the privacy shield request, and wherein the user alias expires based on a completion of the number of subsequent privacy shield transactions using the first user alias, and wherein generating the first user alias further comprises verifying that the first user alias does not match any set of true identifying information of a plurality of true identifying information associated with the user and other users stored in a customer database by comparing the first user alias with the sets of true identifying information of the plurality of true identifying information;
storing, by the privacy shield circuit, the first user alias in the customer database for use in conjunction with the number of subsequent privacy shield transactions in the geographic area, wherein use of the first user alias in conjunction with the subsequent privacy shield transactions includes using the first user alias for at least one of an authentication procedure and providing requested information to a first transaction terminal of a merchant;
associating, by the privacy shield circuit, the first user alias with the plurality of active user aliases associated with the financial account in the customer database, wherein each of the plurality of active user aliases comprise an alias identity and alias identifying information, and wherein the alias identity is different than and not associated with the true identity, and wherein the alias identifying information is different than and not associated with the true identifying information;
determining, by the privacy shield circuit, the user computing device is within the geographic area and at a merchant location where one of the plurality of active user aliases was previously used, wherein determining where one of the plurality of active user aliases was previously used is based on location data received from the user computing device and a transaction history log associated with the one of the plurality of active user aliases;
prompting, by the privacy shield circuit in response to determining the user computing device is within the geographic area, on a display of the user computing device, the authorized user to use a second user alias of the plurality of active user aliases, wherein the second user alias was previously used at the location of the merchant location;
receiving, by the privacy shield circuit over the network via the network circuit, a privacy shield transaction request from a short range wireless transmission at a second transaction terminal, the privacy shield transaction request including the second user alias within the geographic area, wherein the privacy shield transaction request is requested by the user and the second user alias comprises corresponding alias identity and alias identifying information;
matching, by the privacy shield circuit, the second user alias to the one of the plurality of active user aliases, wherein the second user alias is matched to the one of the plurality of active user aliases while maintaining the privacy of the true identity and the true identifying information of the authorized user by preventing the true identity and the true identifying information from being exposed to the merchant;
authorizing, by the privacy shield circuit, the transaction request based on matching the second user alias with the one of the plurality of active user aliases; and
transmitting, by the privacy shield circuit, a confirmation to the second transaction terminal over the network via the network circuit.

14. (canceled)

15. The method of claim 13, wherein the privacy shield request specifies a particular merchant for the number of subsequent privacy shield transaction requests, and wherein a transaction circuit is configured to authorize the privacy shield transaction request based on the privacy shield transaction request being associated with the particular merchant.

16. (canceled)

17. The method of claim 13, wherein the privacy shield circuit is further configured to associate the first user alias with a particular merchant.

18. A non-transitory computer readable media having computer-executable instructions embodied therein that, when executed by a transaction circuit of a financial institution computing system, causes the financial institution computing system to perform operations to authorize a privacy shield transaction request, the operations comprising:
receiving a privacy shield request from an authorized user of a financial account via a user computing device, the privacy shield request comprising a location of the authorized user, and wherein the financial account is associated with a plurality of active user aliases, and wherein the authorized user comprises a true identity and true identifying information;
generating a first user alias for the authorized user of the financial account, the first user alias associated with a status identifier that includes at least a current status of the first user alias, and a geographic area for use in a number of subsequent privacy shield transaction requests, and wherein generating the first user alias is based on the location of the authorized user at a time of the privacy shield request, and wherein the first user alias expires based on a completion of the number of subsequent privacy shield transactions using the first user alias, and wherein generating the first user alias further comprises verifying that the first user alias does not match any set of true identifying information of a plurality of true identifying information associated with the user and other users stored in a customer database by comparing the first user alias with the sets of true identifying information of the plurality of true identifying information;
storing the first user alias in the customer database for use in conjunction with the number of subsequent privacy shield transactions in the geographic area, wherein use of the first user alias in conjunction with the subsequent privacy shield transactions includes using the first user alias for at least one of an authentication procedure and providing requested information to a first transaction terminal of a merchant;
associating the first user alias with the plurality of active user aliases associated with the financial account in the customer database, wherein each of the plurality of active user aliases comprise an alias identity and alias identifying information, and wherein the alias identity is different than and not associated with the true identity, and wherein the alias identifying information is different than and not associated with the true identifying information;
determining the user computing device is within the geographic area and at a merchant location where one of the plurality of active user aliases was previously used, wherein determining where one of the plurality of active user aliases was previously used is based on location data received from the user computing device and a transaction history log associated with the one of the plurality of active user aliases;
prompting, in response to determining the user computing device is within the geographic area, on a display of the user computing device, the authorized user to use a second user alias of the plurality of active user aliases, wherein the second user alias was previously used at the location of the merchant location;
receiving a privacy shield transaction request from a short range wireless transmission at a second transaction terminal, the privacy shield transaction request including the second user alias within the geographic area, wherein the privacy shield transaction request is requested by the user and the second user alias comprises corresponding alias identity and alias identifying information;
matching the second user alias to the one of the plurality of active user aliases, wherein the second user alias is matched to the one of the plurality of active user aliases while maintaining the privacy of the true identity and the true identifying information of the authorized user by preventing the true identity and the true identifying information from being exposed to the merchant;
authorizing the transaction request based on matching the second user alias with the one of the plurality of active user aliases;
causing the second user alias to expire so that the second user alias cannot be used for a subsequent privacy shield transaction; and
transmitting a confirmation to the second transaction terminal over the network via the network circuit.

19. The media of claim 18, wherein the first user alias includes alias transaction information including at least one of an alias card number, an alias card security code, and an alias card expiration date; and
wherein the alias transaction information does not include an actual card number, card security code, or card expiration date of the user.

20. The media of claim 18, wherein the first user alias includes alias personal information including at least one of an alias user name, an alias user address, an alias user birth date, an alias user phone number, and an alias user email address; and
wherein the alias personal information does not include an actual name, address, birth date, phone number, or email address of the user.
